(19) United States
(12) Patent Application Publication
(10) Pub. No.: US 2025/0227821 A1
(43) Pub. Date: Jul. 10, 2025

(54) COOKING APPLIANCE

(71) Applicant: SAMSUNG ELECTRONICS CO., LTD., Suwon-si (KR)

(72) Inventors: Seungchul YANG, Suwon-si (KR); Kiwhan KIM, Suwon-si (KR)

(73) Assignee: SAMSUNG ELECTRONICS CO., LTD., Suwon-si (KR)

(21) Appl. No.: 19/011,031

(22) Filed: Jan. 6, 2025

Related U.S. Application Data
(63) Continuation of application No. PCT/KR2024/018245, filed on Nov. 19, 2024.

(30) Foreign Application Priority Data
Jan. 5, 2024 (KR) 10-2024-0002532

(51) Int. Cl. H05B 6/64

(52) U.S. Cl. CPC H05B 6/6402

(57) ABSTRACT

A cooking appliance includes a main body having a cooking chamber and a machine room; a magnetron in the machine room, to supply high-frequency waves into the cooking chamber, and including a coupler having a fixing hole; and a bracket used to mount the magnetron on the main body and including a support on which a bead to be inserted into the fixing hole is formed. The support is elastically deformable while the magnetron is mounted on the bracket and to be restored after the magnetron is mounted on the bracket to allow the bead to be inserted into the fixing hole.

### CROSS REFERENCE TO THE RELATED APPLICATION

This application is a continuation application, filed under 35 U.S.C. § 111 (a), of International Application PCT/KR2024/018245 filed Nov. 19, 2024, and is based on and claims priority under 35 U.S.C. § 119 to Korean Patent Applications No. 10-2024-0002532, filed on Jan. 5, 2024 in the Korean Intellectual Property Office, the disclosures of which are incorporated by reference herein in their entireties.

### TECHNICAL FIELD

The present disclosure relates to a cooking appliance including a magnetron.

### BACKGROUND ART

Magnetrons generate strong high-frequency waves by controlling the flow of electrons by applying a magnetic field and are used in high-frequency heating devices such as microwave ovens.

In order to install a magnetron in a microwave oven, a method of coupling the magnetron to a bracket is used. Screws and the like may be used to fix or fasten the magnetron, but there is a need to minimize the use thereof in terms of simplification of manufacturing processes and reduction in manufacturing costs.

At the same time, a sufficient fixing force between the bracket and the magnetron needs to be obtained to prevent the magnetron from being separated therefrom while a microwave oven is moved.

### DISCLOSURE

### Technical Problem

Provided is a cooking appliance in which a magnetron is easily mounted on a bracket.

Provided is a cooking appliance in which a magnetron is mounted on a bracket without an additional fastening member.

Provided is a cooking appliance manufactured with increased manufacturing efficiency and reduced costs.

However, the technical problems to be solved by the present disclosure are not limited to the aforementioned problems, and any other technical problems not mentioned herein will be clearly understood from the following description by those skilled in the art to which the present invention pertains.

### Technical Solution

In accordance with an embodiment of the present disclosure, a cooking appliance includes a main body forming a cooking chamber and a machine room, a magnetron located in the machine room, provided to supply high-frequency waves into the cooking chamber, and including a coupler having a fixing hole, and a bracket used to mount the magnetron on the main body and including a support on which a bead provided to be inserted into the fixing hole is formed, wherein the support is designed to be elastically deformable while the magnetron is mounted on the bracket and to be restored after the magnetron is mounted on the bracket allowing the bead to be inserted into the fixing hole.

In accordance with an embodiment of the present disclosure, a cooking appliance includes an inner case forming a cooking chamber, an outer case covering a machine room disposed outside the inner case, a magnetron including a high-frequency generator generating high-frequency waves supplied into the cooking chamber and a yoke forming an accommodation space to accommodate the high-frequency generator, and a bracket provided to couple the magnetron to the inner case, wherein the yoke includes a coupler provided to be coupled to the bracket and having a fixing hole, and the bracket includes a bent support including a bead inserted into the fixing hole.

In accordance with an embodiment of the present disclosure, a cooking appliance includes a main body including an inner case separating a cooking chamber from a machine room, a magnetron located in the machine room, supplying high-frequency waves into the cooking chamber, and including a plurality of couplers having fixing holes, and a bracket provided to couple the magnetron to the inner case, wherein the bracket includes a support provided to support at least one of the plurality of couplers and including a bead inserted into the fixing holes.

In accordance with an embodiment of the present disclosure, a cooking appliance comprises a main body having a cooking chamber and a machine room, a magnetron in the machine room to supply high-frequency waves into the cooking chamber, the magnetron including a coupler having a fixing hole, and a bracket used to mount the magnetron on the main body.

The bracket comprises a bracket body on which the magnetron is mounted, and a support at the bracket body to support the coupler, the support including a bead protruding toward the bracket body to be inserted into the fixing hole.

The support is elastically deformable while the magnetron is mounted on the bracket in a direction opposite to a direction where the bead protrudes by a pressure applied to the bead by the coupler and to be restored after the magnetron is mounted on the bracket to allow the bead to be inserted into the fixing hole.

The coupler comprises a first coupler formed at one side of the magnetron and a second coupler formed at an opposite side of the first coupler, and the support is formed to correspond to at least one of the first coupler and the second coupler.

The support comprises a first bent support to support the first coupler and a second bent support to support the second coupler.

The magnetron further comprises a third coupler at a same side as the first coupler and a fourth coupler at a same side as the second coupler, and the support further comprises a third bend support to support the fourth coupler.

The support further comprises a fourth bent support to support the third coupler.

The magnetron comprises an upper coupler at an upper region of the magnetron and a lower coupler at a lower region of the magnetron.

The support is to support the upper coupler, and the bracket further comprises a support slot to support the lower coupler.

The upper coupler comprises a first upper coupler and a second upper coupler formed at a same side as the first upper coupler, and the support is to support the first upper coupler. The second upper coupler is coupled to the bracket by a fastening member.

The lower coupler comprises a first lower coupler symmetrically arranged to the first upper coupler and a second lower coupler symmetrically arranged to the second upper coupler, and the support slot comprises a first support slot to support the first lower coupler, and a second support slot to support the second lower coupler.

The support slot comprises a bead to be inserted into the fixing hole.

The support slot comprises a slope formed by partially inclining the support slot to allow the lower coupler to be slantly inserted to the support slot.

The magnetron is mounted by inserting the lower coupler into the support slot along the slope and rotating the magnetron in a state of being inserted in the support slot to join the upper coupler to the support.

The magnetron further comprises a high-frequency generator configured to generate high-frequency waves supplied into the cooking chamber and a yoke forming an accommodation space to accommodate the high-frequency generator.

The yoke comprises a yoke main body with one side open and a yoke cover, on which the support is formed, forming the accommodation space by covering the open side of the yoke main body.

The support is formed by lancing.

The support slot comprises a first support slot to support the first coupler the first support slot including a first bead, and a second support slot to support the second coupler, the second support slot including a second bead, and in response to inserting the second coupler into the second support slot thereby inserting the second bead into a fixing hole of the second coupler, the bracket is rotated with respect to the second bead so that the first coupler is inserted into the first support slot thereby inserting the first bead into a fixing hole of the first coupler to mount the magnetron to the bracket.

The first support slot includes a first bead and the second support slot includes a second bead, and in response to inserting the second lower coupler into the second support slot thereby inserting the second bead into a fixing hole of the second lower coupler, the bracket is rotated with respect to the second bead so that the first lower coupler is inserted into the first support slot thereby inserting the first bead into a fixing hole of the first lower coupler to mount the magnetron to the bracket.

### DESCRIPTION OF DRAWINGS

FIG. 1 is a perspective view of a cooking appliance according to an embodiment of the present disclosure.

FIG. 2 is an exploded view illustrating some components of the cooking appliance shown in FIG. 1.

FIG. 3 is a cross-sectional view of a part of the cooking appliance shown in FIG. 1.

FIG. 4 is a view illustrating a state where a magnetron is mounted on a bracket according to an embodiment of the present disclosure.

FIG. 5 is a view illustrating a state where the magnetron is separated from the bracket in FIG. 4.

FIG. 6 is a front view of the bracket of FIG. 4.

FIG. 7 is a view for describing a method of mounting the magnetron on the bracket of FIG. 4.

FIG. 8 is an enlarged view illustrating a part of the mounted structure of the magnetron on the bracket of FIG. 4.

FIG. 9 is an enlarged view illustrating some components of the brackets of FIG. 6.

FIG. 10 is a view illustrating a state where a magnetron is mounted on a bracket according to an embodiment of the present disclosure.

FIG. 11 is a front view of the bracket of FIG. 10.

FIG. 12 is a view for describing a method of mounting the magnetron on the bracket of FIG. 10.

FIG. 13 is a view illustrating a state where a magnetron is mounted on a bracket according to an embodiment of the present disclosure.

FIG. 14 is a front view of the bracket of FIG. 13.

FIG. 15 is a view for describing a method of mounting the magnetron on the bracket of FIG. 13.

FIG. 16 is a view illustrating a state where a magnetron is mounted on a bracket according to an embodiment of the present disclosure.

FIG. 17 is a front view of the bracket of FIG. 16.

FIG. 18 is a view for describing a method of mounting the magnetron on the bracket of FIG. 16.

FIG. 19 is a view illustrating a state where a magnetron is mounted on a bracket according to an embodiment of the present disclosure.

FIG. 20 is a view for describing a method of mounting the magnetron on the bracket of FIG. 19.

FIG. 21 is a view illustrating a state where a magnetron is mounted on a bracket according to an embodiment of the present disclosure.

FIG. 22 is a view for describing a method of mounting the magnetron on the bracket of FIG. 21.

### BEST MODE

The embodiments described in the specification and shown in the drawings are only illustrative and are not intended to represent all aspects of the present disclosure, such that various equivalents and modifications may be made without departing from the spirit of the present disclosure.

In addition, like reference numerals denote like elements or components having substantially same functions in the drawings.

Also, the terms used herein are merely used to describe particular embodiments, and are not intended to limit the present disclosure. An expression used in the singular encompasses the expression of the plural, unless otherwise indicated. Throughout the specification, the terms such as “including” or “having” are intended to indicate the existence of features, numbers, operations, components, parts, or combinations thereof disclosed in the specification, and are not intended to preclude the possibility that one or more other features, numbers, operations, components, parts, or combinations thereof may exist or may be added.

In addition, it will be understood that, although the terms “first”, “second”, etc., may be used herein to describe various elements, these elements should not be limited by these terms. The above terms are used only to distinguish one component from another. For example, a first component discussed below could be termed a second component, and similarly, the second component may be termed the first component without departing from the teachings of this disclosure. As used herein, the term “and/or” includes any combinations of one or more of the associated listed items.

Meanwhile, the terms used throughout the specification “vertical direction”, “below”, “forward-backward direction”, and the like are defined based on the drawings and the shape and position of each element are not limited by these terms.

Hereinafter, embodiments of the present disclosure will be described in detail with reference to the accompanying drawings.

Although a microwave oven will be described as an example of the cooking appliance for the convenience of description, the configuration of the present disclosure is not limited to the microwave oven and may also be applied to other types of cooking appliance. For example, the present disclosure may also be applied to electric ovens including microwave functions.

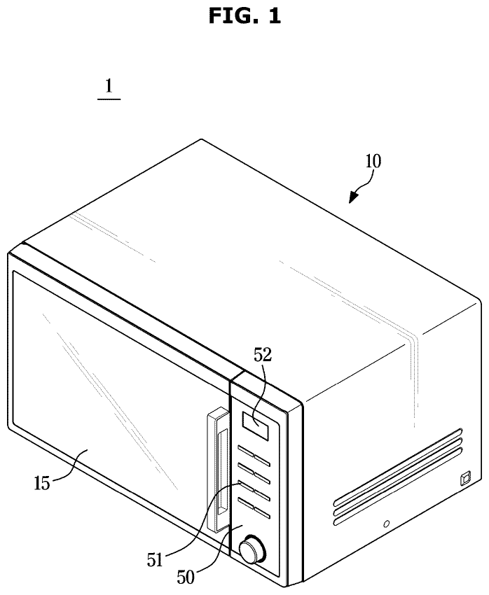

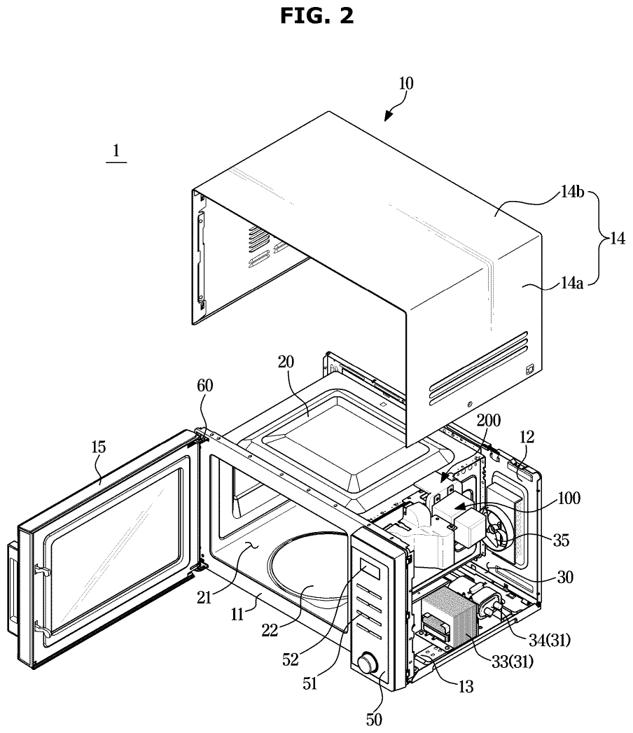

FIG. 1 is a perspective view of a cooking appliance according to an embodiment of the present disclosure. FIG. 2 is an exploded view illustrating some components of the cooking appliance shown in FIG. 1.

Referring to FIGS. 1 and 2, a cooking appliance 1 may include a main body 10 defining an external appearance. The main body 10 may include a front panel 11, a rear panel 12, a bottom panel 13, and a cover 14. The cover 14 may be disposed between the front panel 11 and the rear panel 12. The cover 14 may include a side panel 14a and a top panel 14b. The side panel 14a may be integrated with the top panel 14b. The side panel 14a and the top panel 14b may be provided as separate components.

The cooking appliance 1 may include an inner case 20 forming a cooking chamber 21. The inner case 20 may be provided in the main body 10. The inner case 20 may have an approximate rectangular shape with one side open. A machine room 30 may be disposed between the main body 10 and the inner case 20.

The cooking appliance 1 may include a heating source 31 configured to cook an object to be cooked. For example, the heating source 31 may include a magnetron 100 provided to generate high-frequency waves supplied into the cooking chamber 21 and a high-voltage transformer 33 and a high-voltage condenser 34 both configured to apply a high voltage to the magnetron 100. The magnetron 100, the high-voltage transformer 33, and the high-voltage condenser 34 may be located in the machine room 30. The cooking appliance 1 may include a cooling fan 35 configured to cool the components inside the machine room 30. The cooling fan 35 may be located in the machine room 30.

The cooking appliance 1 may include a tray 22 located in the cooking chamber 21 to accommodate the object to be cooked.

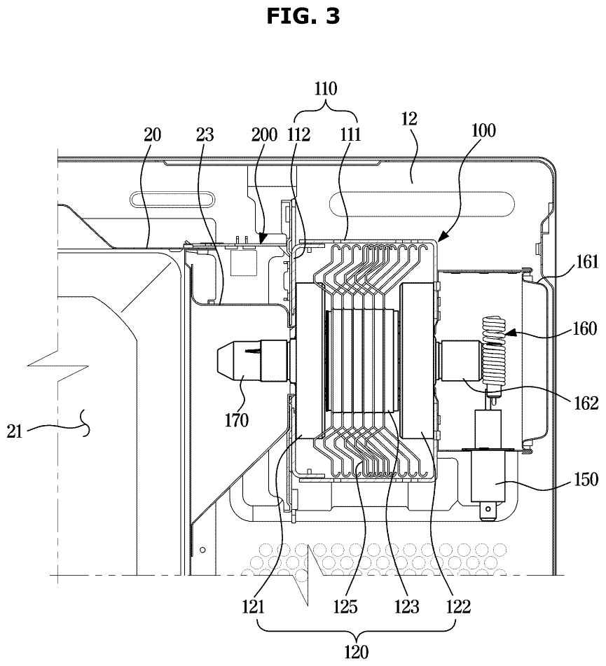

The cooking appliance 1 may include a waveguide 23 (See FIG. 3) provided to guide high-frequency waves emitted from the magnetron 100 into the cooking chamber 21.

The cooking appliance 1 may cook the object to be cooked by radiating the high-frequency waves into the cooking chamber 21 in a state where the object to be cooked is accommodated in the tray 22. While the cooking appliance 1 radiates the high-frequency waves into the cooking chamber 21, molecular arrangement of moisture contained in the object to be cooked and accommodated in the tray 22 is repeatedly altered to generate frictional heat between the molecules so that the object is cooked.

For example, the heating source 31 may include a heater for heating the inside of the cooking chamber 21.

The cooking appliance 1 may include a door 15 coupled to the front panel 11 of the main body 10 for opening and closing of the cooking chamber 21. The door 15 may be pivotally coupled to the main body 10. The door 15 may be constructed by including a transparent or translucent material to show the interior of the cooking chamber 21 through at least a part thereof.

The cooking appliance 1 may include a control panel 50 including an input interface 51 configured to receive a user input and/or a display 52 configured to display information.

The control panel 50 may be coupled to the front panel 11 of the main body 10. The control panel 50 may be arranged at one side of the door 15. The control panel 50 may be located at one end of the front panel 11 opposite to the other end where a hinge 60 pivotally supporting the door 15 is located. The control panel 50 may be a component included in the main body 10.

FIG. 3 is a cross-sectional view of a part of the cooking appliance illustrated in FIG. 1.

Referring to FIG. 3, the magnetron 100 may include a yoke 110 having an accommodation space therein.

The yoke 110 may include a yoke main body 111 having one side open, and a yoke cover 112 covering the open side of the yoke main body 111. The yoke cover 112 may form the accommodation space by covering the open side of the yoke main body 111.

The yoke cover 112 may be coupled to a bracket 200 which will be described below. The bracket 200 may be coupled to the inner case 20. Specifically, the bracket 200 may be coupled to the waveguide 23 provided to guide the high-frequency waves into the cooking chamber 21. A coupled structure of the magnetron 100 and the bracket 200 will be described in more detail below.

The magnetron 100 may include a high-frequency generator 120 installed in the accommodation space of the yoke 110 and configured to generate high-frequency waves. That is, the high-frequency generator 120 may be installed in the accommodation space in the yoke 110.

The high-frequency generator 120 may include a first magnet 121 and a second magnet 122 arranged to face the first magnet 121. The first magnet 121 may be an annular permanent magnet at the output side and the second magnet 122 may be an annular permanent magnet at the input side.

The high-frequency generator 120 may include a positive electrode 130 disposed between the first magnet 121 and the second magnet 122 and a negative electrode (not shown) disposed in the positive electrode 130.

The yoke 110, the first magnet 121, and the second magnet 122 may be arranged to surround the positive electrode 130 and the negative electrode (not shown), thereby constituting a magnetic circuit.

The magnetron 100 may include an input device 150 configured to supply a power to the high-frequency generator 120. The input device 150 may be a capacitor that supplies the power.

The input device 150 may include a pair of input terminals (not shown) accessed to a pair of central lead (not shown) and side lead (not shown). The input device 150 may further include a plug connected to the pair of input terminals (not shown) for supplying power.

The magnetron 100 may include a filter 160 electrically connected to the input device 150.

The filter 160 may include a plurality of filters accessed to the input device 150. The plurality of filters may be formed of a choke coil. The filter 160 may attenuate low-frequency noise.

The filter 160 may include a filter case 161 coupled to the yoke main body 111 to prevent electromagnetic waves generated in the positive electrode 123 from leaking to the outside. The input device 150 may be located to penetrate the filter case 161.

The magnetron 100 may include an output device 170 configured to radiate the high-frequency waves generated by the high-frequency generator 120 out of the yoke 110.

The output device 170 may penetrate the yoke cover 112 to be exposed so as to radiate the high-frequency waves into the cooking chamber 21. The exposed output device 170 may be located in the waveguide 23.

The high-frequency generator 120 may include cooling fins 125 disposed in the accommodation space and arranged around the positive electrode 130. The cooling fin 125 may cool the positive electrode 130.

The negative electrode (not shown) may include a coil-shaped filament (not shown), a central lead (not shown), and a side lead (not shown). The central lead (not shown) and the side lead (not shown) may be connected to an external power source to supply the power to the filament (not shown) and the central lead (not shown) and the side lead (not shown) may be fixed by being surrounded by the insulator 162.

The central lead (not shown) and the side lead (not shown) may be electrically connected to the input device 150. Once the power is applied to the central lead (not shown) and the side lead (not shown), the filament (not shown) may emit thermoelectrons toward a vane (not shown) of the positive electrode 130.

The cooking appliance 1 may circulate external air in the machine room 30 by operating the cooling fan 35 configured to remove heat generated in the magnetron 100 or the high-voltage transformer 33 therefrom during the operation.

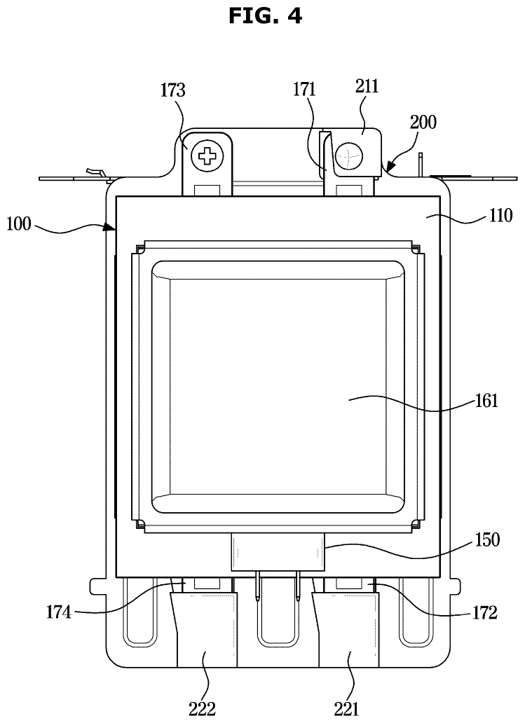

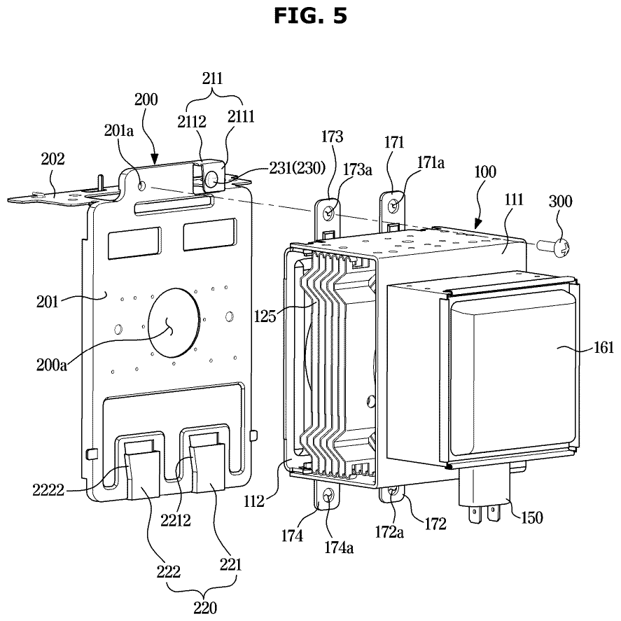

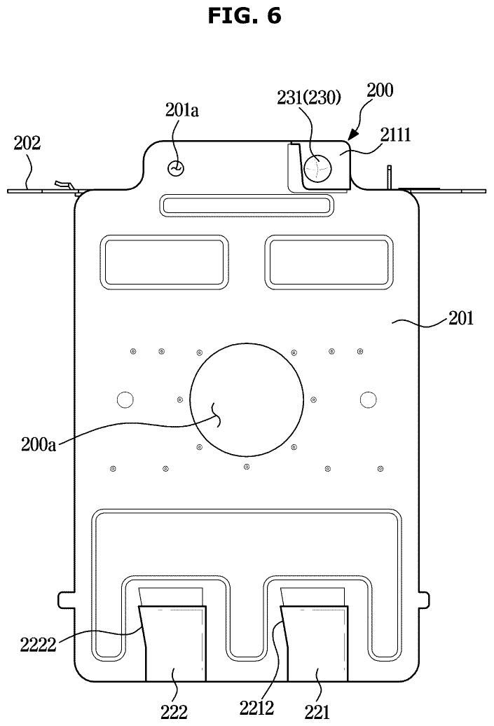

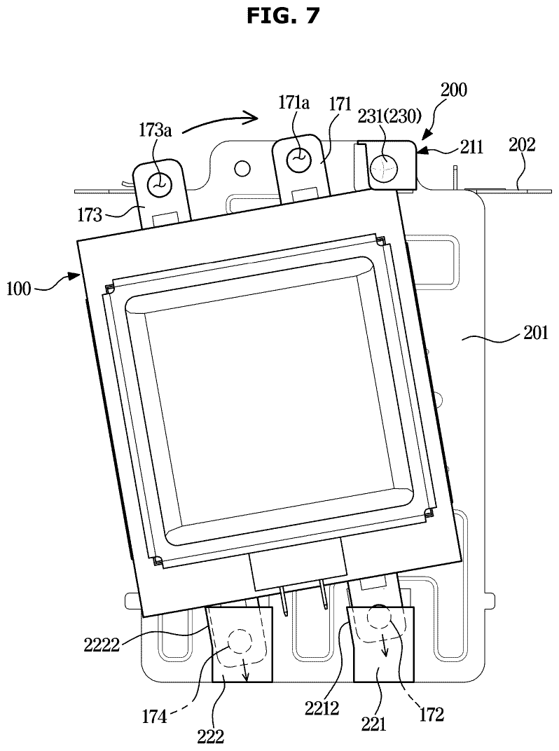

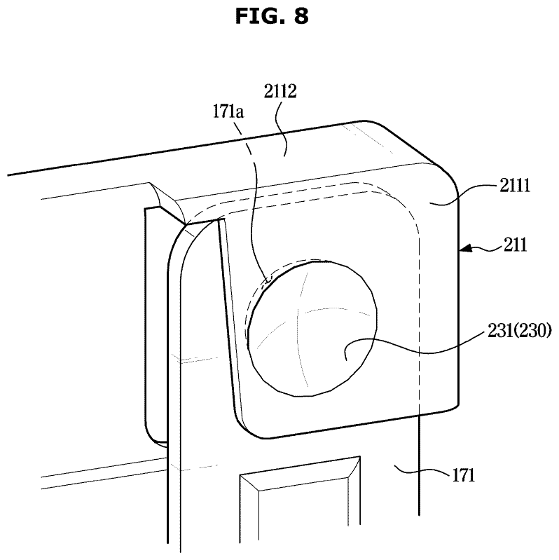

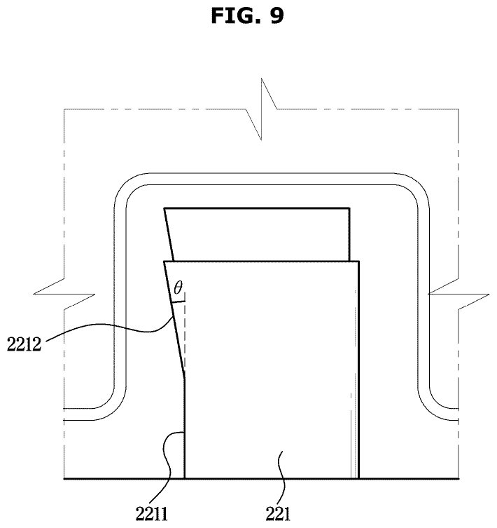

FIG. 4 is a view illustrating a state where a magnetron is mounted on a bracket according to an embodiment of the present disclosure. FIG. 5 is a view illustrating a state where the magnetron is separated from the bracket in FIG. 4. FIG. 6 is a front view of the bracket of FIG. 4. FIG. 7 is a view for describing a method of mounting the magnetron on the bracket of FIG. 4. FIG. 8 is an enlarged view illustrating a part of the mounted structure of the magnetron on the bracket of FIG. 4. FIG. 9 is an enlarged view illustrating some components of the brackets of FIG. 6.

Referring to FIGS. 4 to 9, the magnetron 100 may be mounted on the bracket 200.

The magnetron 100 may include a plurality of couplers 171, 172, 173, and 174 formed at one side of the yoke 110. Fixing holes 171a, 172a, 173a, and 174a may be formed respectively in the plurality of couplers 171, 172, 173, and 174. As shown in the drawings, the plurality of couplers 171, 172, 173, and 174 may be formed in two on each of the opposite sides, but the embodiment is not limited thereto, and the couplers may be formed in one on each side.

The plurality of couplers 171, 172, 173, and 174 may be formed by extending from the yoke 110 by a predetermined length. Specifically, the plurality of couplers 171, 172, 173, and 174 may be formed by extending from the yoke cover 112 by a predetermined length.

The plurality of couplers 171, 172, 173, and 174 may include a first coupler 171 provided at one side of the magnetron 100 and a second coupler 172 provided at the other side of the magnetron 100. In other words, the plurality of couplers 171, 172, 173, and 174 may include a first coupler 171 provided at one side of the magnetron 100 and a second coupler 172 provided at the other side opposite to the first coupler 171.

In addition, the plurality of couplers 171, 172, 173, and 174 may include a third coupler 173 formed at the same side as the first coupler 171 and a fourth coupler 174 formed at the same side as the second coupler 172. The first coupler 171 and the second coupler 172 may be symmetrically arranged to each other and the third coupler 173 and the fourth coupler 174 may be symmetrically arranged to each other.

In addition, the plurality of couplers 171, 172, 173, and 174 may include upper couplers 171 and 173 provided at upper regions of the magnetron 100 and lower couplers 172 and 174 provided at lower regions of the magnetron 100.

The upper couplers 171 and 173 may be provided symmetrically to the lower couplers 172 and 174. In addition, the upper couplers 171 and 173 and the lower couplers 172 and 174 may extend by the same length.

The upper couplers 171 and 173 may include a first upper coupler 171 and a second upper coupler 173 formed at the same side as the first upper coupler 171.

The lower couplers 172 and 174 may include a first lower coupler 172 provided symmetrically to the first upper coupler 171 and a second lower coupler 174 provided symmetrically to the second upper coupler 173.

The yoke 110 may include the first coupler 171 formed at one side and the second coupler 172 formed the other side opposite to the first coupler 171. The first coupler 171 and the second coupler 172 may extend in opposite directions.

The bracket 200 may include a bracket body 201 in which an antenna hole 200a is formed. The bracket body 201 may have an approximate plate shape. The bracket body 201 may be in contact with the magnetron 100.

The bracket body 201 may be provided to seat the magnetron 100 thereon. Specifically, the yoke cover 112 of the magnetron 100 may be arranged to be in contact with the bracket body 201.

The bracket 200 may have a mount 202 bent from the bracket body 201. The mount 202 may be supported by the upper side of the inner case 20. The mount may be provided such that the bracket 200 is in contact with the waveguide 23 (See FIG. 3). Specifically, in the state where the magnetron 100 is mounted on the bracket 200, the output device 170 may be located in the waveguide 23. The bracket 200 may mediate the coupling of the waveguide 23 to the magnetron 100.

The bracket 200 may include a support 211 provided to support the plurality of couplers 171, 172, 173, and 174.

The support 211 may be provided to install the magnetron 100. Specifically, the yoke 110 may be fixed to the support 211. At least some of the plurality of couplers 171, 172, 173, and 174 of the yoke 110 may be supported by the support 211. For example, as shown in the drawings, the first coupler 171 may be supported by the support 211.

The support 211 may be formed by lancing the bracket body 201. Specifically, the support 211 may be formed by partially cutting the bracket body 201 and bending the cut portion by pressing.

The support 211 may be formed to correspond to at least one of the plurality of couplers 171, 172, 173, and 174. Because the support 211 is provided to install the first coupler 171 herein, the support 211 may be formed at a position corresponding to the first coupler 171.

A bead 231 may be formed at the support 211. The bead 231 may have an approximate hemisphere shape. However, the shape of the bead 231 is not limited thereto. For example, the bead 231 may be provided to have various shapes such as a triangle and a quadrangle.

The support 211 may include a bead-forming surface 2111 on which the bead 231 is formed.

The bead-forming surface 2111 may be provided to be parallel to the bracket body 201. The first coupler 171 may be inserted between the bead-forming surface 2111 and the bracket body 201. As the first coupler 171 is inserted, the bead 231 may be inserted into the first coupling hole 171a formed in the first coupler 171. Therefore, the bead 231 may protrude toward the bracket body 201 from the bead-forming surface 2111.

The support 211 may include a movement-limiting surface 2112 bent from the bead-forming surface 2111.

The movement-limiting surface 2112 may prevent the first coupler 171 mounted on the support 211 from deviating from a coupling position. The movement-limiting surface 2112 may be formed in a direction other than a direction in which the first coupler 171 is inserted. That is, the movement-limiting surface 2112 may be formed with one open side into which the first coupler 171 is inserted. In addition, the movement-limiting surface 2112 may be formed to surround the first coupler 171 when the first coupler 171 is installed.

The bracket 200 may include support slots 221 and 222 provided to support the lower couplers 172 and 174.

The support slots 221 and 222 may be provided to allow the lower couplers 172 and 174 to be inserted thereinto. The support slots 221 and 222 may include a first support slot 221 provided to support the first lower coupler 172 and a second support slot 222 provided to support the second lower coupler 174.

The support slots 221 and 222 may include slopes 2212 and 2222 formed by partially inclining the support slots 221 and 222 to allow the lower couplers 172 and 174 to be slantly inserted thereinto.

Referring to FIGS. 7 to 9, a method of mounting the magnetron 100 on the bracket 200 will be described.

To mount the magnetron 100 on the bracket 200, the first upper coupler 171 may be configured not to be interfered with by the support 211. Specifically, while the lower couplers 172 and 174 are inserted into the support slots 221 and 222, the first upper coupler 171 may be interfered with by the support 211. Therefore, by slantly inserting the lower couplers 172 and 174 into the support slots 221 and 222, the first upper coupler 171 may avoid the support 211.

The first upper coupler 171 may be inserted into the open side of the support 211. Therefore, the first upper coupler 171 may be located to be slanted toward the open side of the support 211. Because the upper couplers 171 and 173 area arranged symmetrically to the lower couplers 172 and 174, the lower couplers 172 and 174 may also be located to be slanted in the same direction as that of the first upper coupler 171. That is, the slopes 2212 and 2222 along which the lower couplers 172 and 174 move may also be slanted toward the open side of the support 211.

After the lower couplers 172 and 174 are slantly inserted into the support slots 221 and 222, the first upper coupler 171 may rotate about the lower couplers 172 and 174, as rotation shafts, toward the support 211. While rotating, the first upper coupler 171 may be inserted into the open side of the support 211.

While the magnetron 100 is mounted on the bracket 200, the support 211 may be elastically deformed. While being inserted into the support 211, the first coupler 171 of the magnetron 100 may press the bead 231 protruding toward the bracket body 201 and the bead-forming surface 2111 on which the bead 231 is formed.

The bead-forming surface 211 may be pressed in a direction opposite to the protruding direction of the bead 231. That is, the support 211 may be elastically deformed in a direction where a gap between the bead-forming surface 2111 and the bracket body 201 widens.

After the magnetron 100 is mounted on the bracket 200, the support 211 may be elastically restored. When the first coupler 171 of the magnetron 100 is coupled to the support 211, the bead 231 may be inserted into the fixing hole 171a of the first coupler 171. As such, the pressed state of the bead 231 is released so that the support 211 may be elastically restored.

A tilt angle (θ) between the slope 2212 and the movement-limiting surface 2211 of the support slot 221 may be about 10°. Specifically, the tilt angle (θ) may be about 5° to about 15°. However, the tilt angle (θ) is not limited thereto and may be any angle as long as there is no interference between the first upper coupler 171 and the support 211.

Referring back to FIG. 5, the magnetron 100 may be coupled to the support slots 221 and 222 and the support 211 of the bracket 200. After the magnetron 100 is mounted to the bracket 200, the fixing hole 173a formed in the second upper coupler 173 may be located to correspond to the fastening hole 201a formed in the bracket body 201.

The magnetron 100 may be fastened to the bracket 200 by the fastening member 300 for stronger coupling therebetween. The fastening member 300 may be inserted into the fixing hole 173a and the fastening hole 201a for fastening.

The fastening member 300 may be provided as a bolt. However, the type of the fastening member 300 is not limited thereto and the fastening member 300 may be provided in various forms such as a pin or a rivet.

As described above, the magnetron 100 according to an embodiment of the present disclosure may be mounted on the bracket 200 without the fastening member 300. Alternatively, the magnetron 100 may be mounted on the bracket 200 by using only one fastening member 300.

By using the bracket 200 according to an embodiment of the present disclosure, the number of required fastening members 300 may be reduced, and accordingly effects on reducing in manufacturing costs and increasing in production efficiency may be obtained.

Hereinafter, another embodiment different from that of FIGS. 4 to 9 will be described. The same reference numerals are given to the same components and descriptions thereof may be omitted and different components will be described in detail.

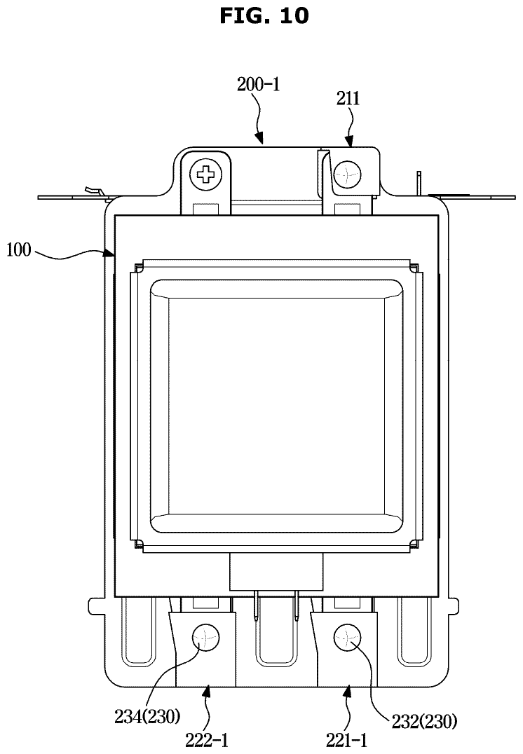

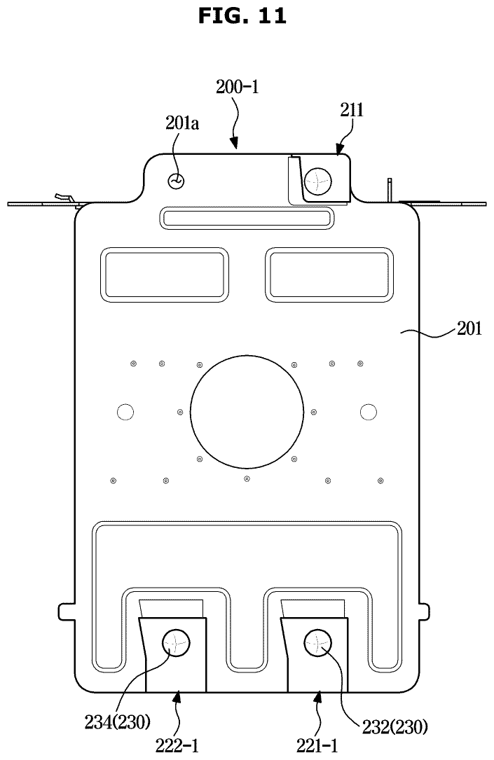

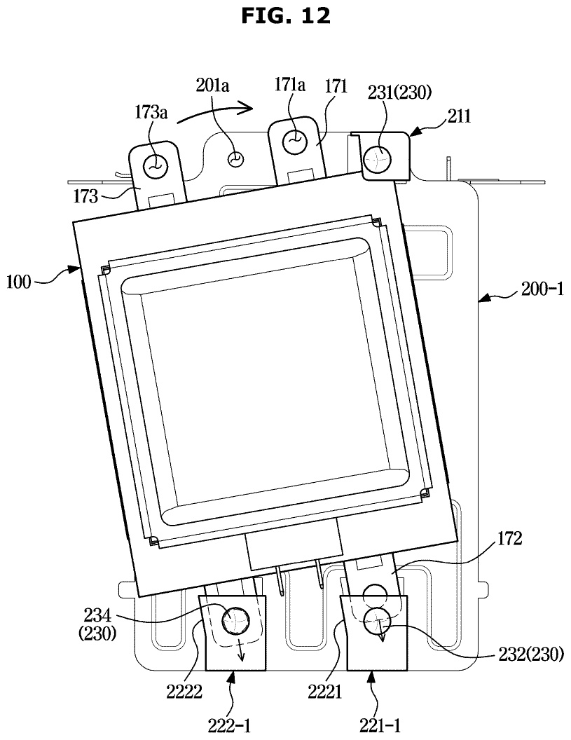

FIG. 10 is a view illustrating a state where a magnetron is mounted on a bracket according to an embodiment of the present disclosure. FIG. 11 is a front view of the bracket of FIG. 10. FIG. 12 is a view for describing a method of mounting the magnetron on the bracket of FIG. 10.

Referring to FIGS. 10 to 12, a bracket 200-1 may include support slots 221-1 and 222-1 provided to support the lower couplers 172 and 174.

The support slots 221-1 and 222-1 may include a first support slot 221-1 provided to support the first lower coupler 172 and a second support slot 222-1 provided to support the second lower coupler 174.

The first support slot 221-1 may include a bead 232 provided to be inserted into the fixing hole 172a of the first lower coupler 172. In addition, the second support slot 222-1 may include a bead 234 provided to be inserted into the fixing hole 174a of the second lower coupler 174.

When the first lower coupler 172 is inserted into the first support slot 221-1, the bead 232 of the first support slot 221-1 may be inserted into the fixing hole 172a of the first lower coupler 172. In addition, when the first lower coupler 172 is inserted into the first support slot 221-1, the bead 234 of the second support slot 222-1 may be inserted into the fixing hole 174a of the second lower coupler 174.

The magnetron 100 may be mounted on the bracket 200-1.

The lower couplers 172 and 174 of the magnetron 100 may first be inserted into the support slots 221-1 and 222-1. The second lower couplers 174 may first be fixed by the bead 234 formed on the second support slot 222-1. Subsequently, while the first lower coupler 172 is fixed by the bead 232 formed on the first support slot 221-1, the first upper coupler 171 may also be fixed by the bead 231 of the support 211.

By forming the beads 232 and 234 on the first support slot 221-1 and the second support slot 222-1, the number of components fixing the magnetron 100 may increase. That is, because all of the four couplers 171, 172, 173, and 174 of the magnetron 100 are fixed, stability may be improved.

In addition, by fixing the lower couplers 172 and 174, the magnetron 100 may be fixed in a right position first. That is, the magnetron 100 may be more easily mounted on the bracket 200-1 in the right position.

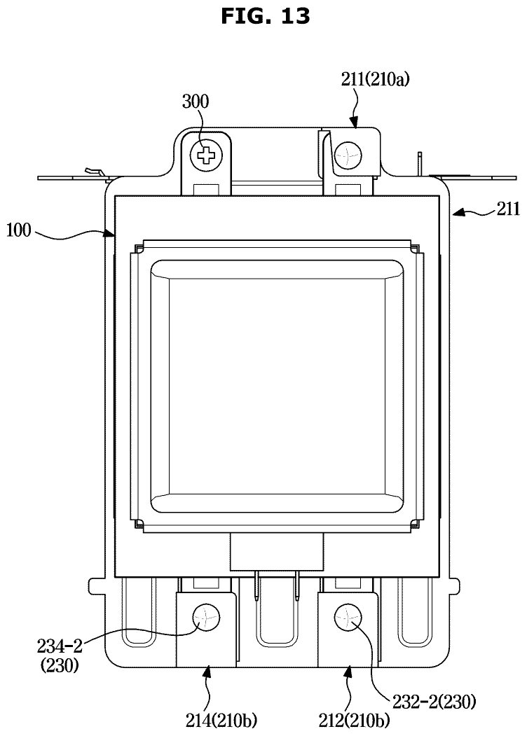

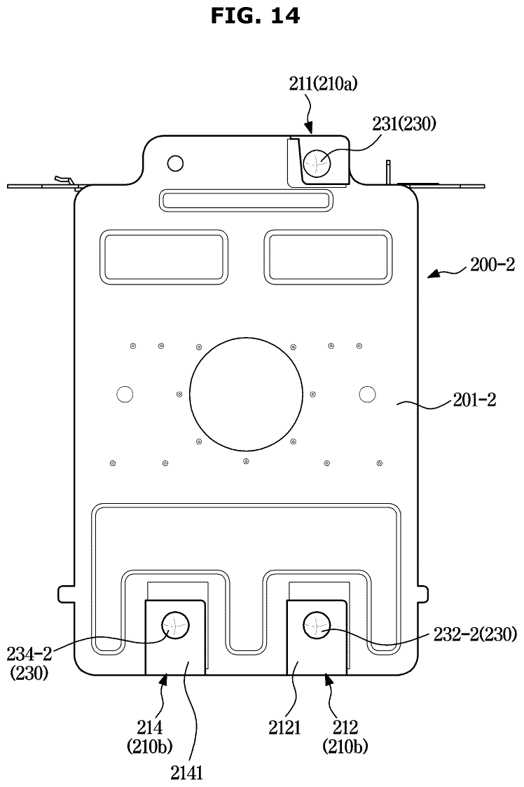

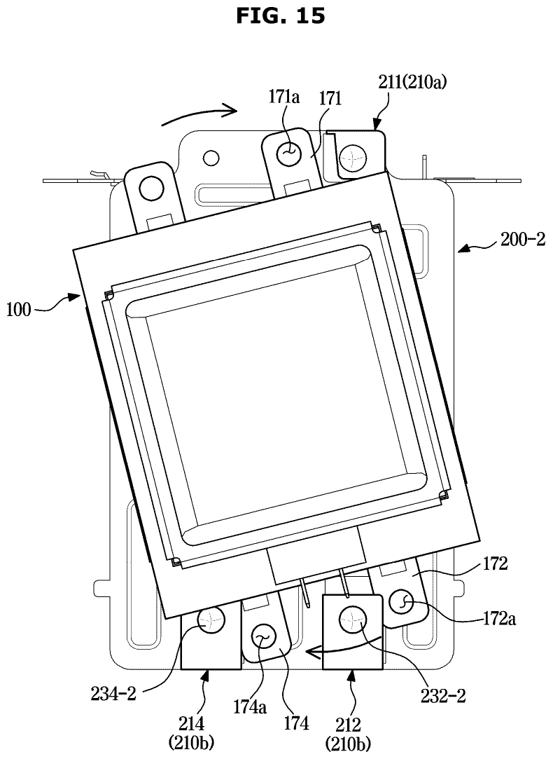

FIG. 13 is a view illustrating a state where a magnetron is mounted on a bracket according to an embodiment of the present disclosure. FIG. 14 is a front view of the bracket of FIG. 13. FIG. 15 is a view for describing a method of mounting the magnetron on the bracket of FIG. 13.

A bracket 200-2 according to an embodiment of the present disclosure may include supports 211, 212, and 214 provided to support couplers 171, 172, and 174.

The magnetron 100 may include a plurality of couplers 171, 172, 173, and 174. In other word, the magnetron 100 may include a first coupler 171, a second coupler 172, a third coupler 173, and a fourth coupler 174. In other words, the magnetron 100 may include upper couplers 171 and 173 and lower couplers 172 and 174.

The supports 211, 212, and 214 may include an upper support 210a provided to support the upper coupler 171. In addition, the supports 211, 212, and 214 may include lower supports 210b provided to support the lower couplers 172 and 174.

The supports 211, 212, and 214 may include a first bent support 211 provided to support the first coupler 171. That is, the upper support 211 may be the first bent support 211.

The first bent support 211 may be formed by lancing the bracket body 201. The first bent support 211 may be formed by being bent from the bracket body 201.

In addition, the supports 211, 212, and 214 may include a second bent support 212 provided to support the second coupler 172. The second bent support 212 may also be formed by lancing.

At least a part of the second bent support 212 may be open such that the second coupler 172 is inserted thereinto. Specifically, one side of the second bent support 212 may be open. However, the embodiment is not limited thereto and both sides of the second bent support 212 may be open.

The bracket 200-2 may include a third bent support 214 provided to support the fourth coupler 174. Like the second bent support 212, one side of the third bent support 214 may be open. The third bent support 214 may be provided at a lower region of the bracket 200-2 together with the second bent support 212.

Each of the second coupler 172 and the fourth coupler 174 may be inserted into the open side of the second bent support 212 and the third bent support 214. That is, the second coupler 172 may be inserted into a space between a bead-forming surface 2121 of the second bent support 212 and the bracket body 201-2. In the same manner, the fourth coupler 174 may be inserted into a space between a bead-forming surface 2141 of the third bent support 214 and the bracket body 201-1.

A bead 232-2 formed on the second bent support 212 and a bead 234-2 formed on the third bent support 214 may be respectively inserted into fixing holes 172a and 174a formed in the second coupler 172 and the fourth coupler 174.

In order to mount the magnetron 100 on the bracket 200-2 according to an embodiment of the present disclosure, the second coupler 172 and the fourth coupler 174, i.e., the lower couplers 172 and 174, may not be first inserted into the second bent support 212 and the third bent support 214.

The first coupler 171, the second coupler 172, and the fourth coupler 174 may be simultaneously fixed to the first bent support 211, the second bent support 212, and the third bent support 214, respectively.

The bracket 200-2 according to an embodiment of the present disclosure may allow the magnetron 100 to be easily mounted thereon. That is, manufacturing efficiency of the cooking appliance 1 including the magnetron 100 may be increased thereby.

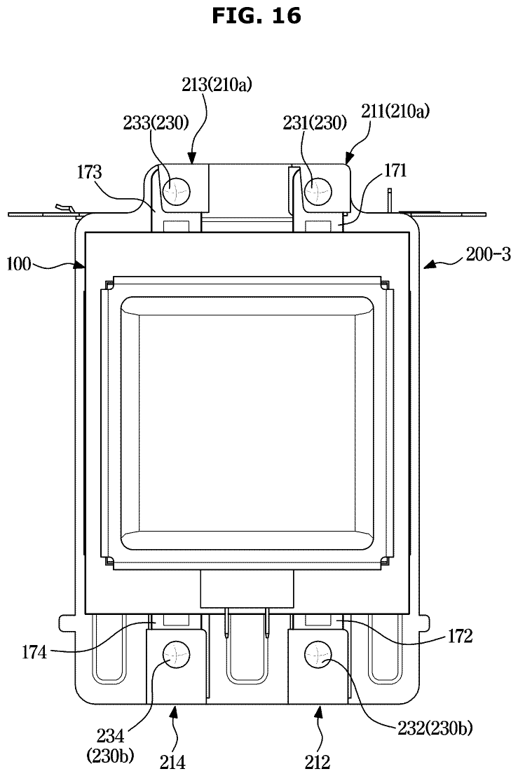

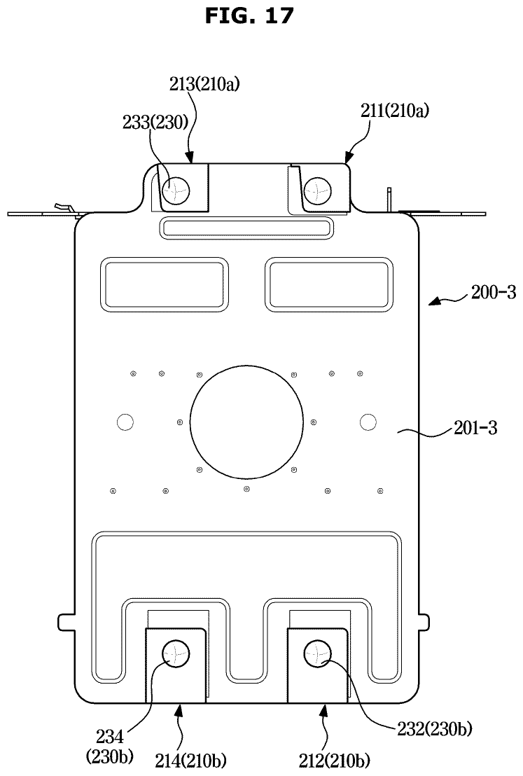

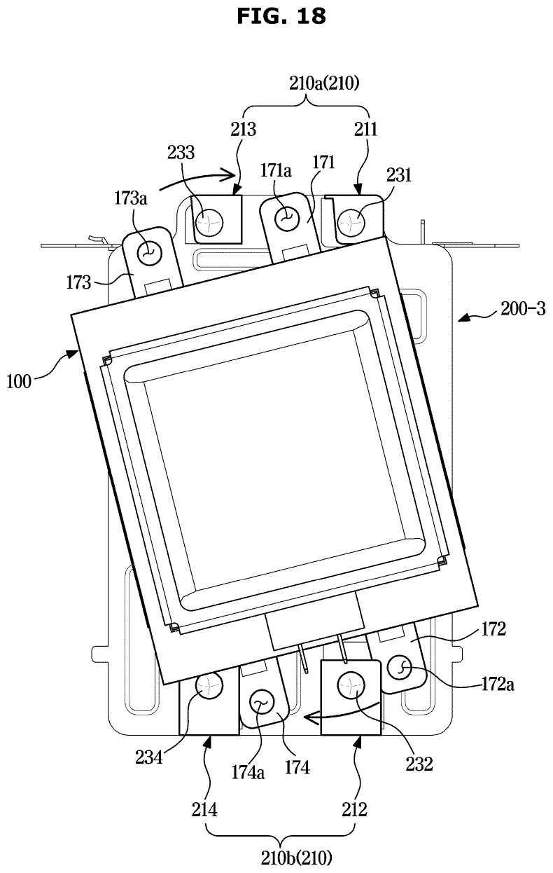

FIG. 16 is a view illustrating a state where a magnetron is mounted on a bracket according to an embodiment of the present disclosure. FIG. 17 is a front view of the bracket of FIG. 16. FIG. 18 is a view for describing a method of mounting the magnetron on the bracket of FIG. 16.

Referring to FIGS. 16 to 18, a bracket 200-3 according to an embodiment of the present disclosure may include a fourth bent support 213 provided to support the third coupler 173.

A bead 233 may be formed on the fourth bent support 213 in the same manner as on the first bent support 211. In addition, one side thereof may be open in the same direction as that of the first bent support 211.

The first bent support 211 and the fourth bent support 213 may be provided to support the first coupler 171 and the third coupler 173, respectively. The first coupler 171 may be inserted into the open side of the first bent support 211. In addition, the third coupler 173 may be inserted into the open side of the fourth bent support 213. Therefore, the first bent support 211 and the fourth bent support 213 may be partially open in the same direction.

The magnetron 100 may be mounted on the bracket 200-3 according to an embodiment of the present disclosure without an additional fastening member (not shown).

The couplers 171, 172, 173, and 174 of the magnetron 100 may be fixed by the supports 211, 212, 214, and 213, respectively. As described above, because all of the four couplers 171, 172, 173, and 174 are fixed by the supports 211, 212, 214, and 213, an additional fastening member (not shown) may not be required.

Because the magnetron 100 may be mounted on the bracket 200-3 according to an embodiment of the present disclosure without the additional fastening member 300, manufacturing costs may be reduced. In addition, there is no need to fix the upper couplers 171 and 173 after fixing the lower couplers 172 and 174 first, manufacturing efficiency may also be increased.

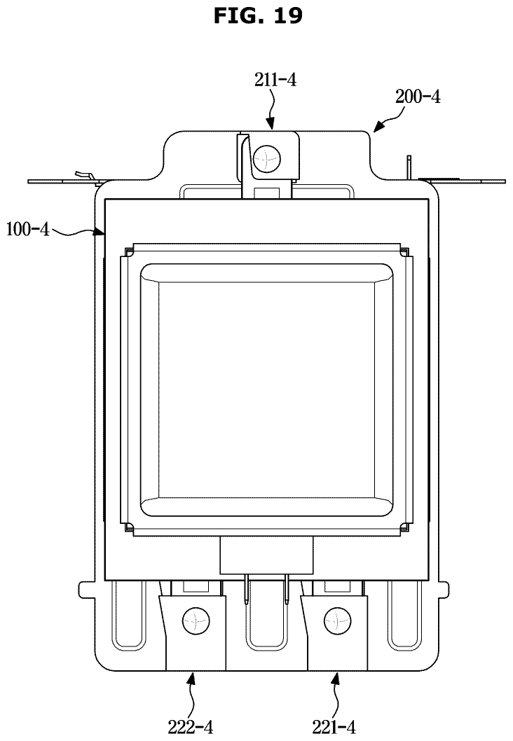

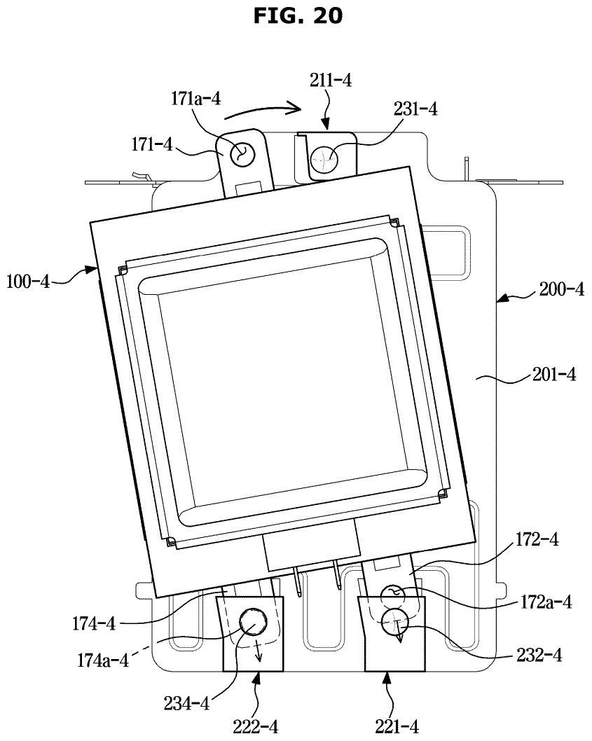

FIG. 19 is a view illustrating a state where a magnetron is mounted on a bracket according to an embodiment of the present disclosure. FIG. 20 is a view for describing a method of mounting the magnetron on the bracket of FIG. 19.

Referring to FIGS. 19 and 20, a magnetron 100-4 according to an embodiment of the present disclosure may include a first coupler 171-4 disposed at one side. A fixing hole 171a-4 for fixing may be formed in the first coupler 171-4. The first coupler 171-4 may be disposed at an upper region of the magnetron 100-4.

In addition, the magnetron 100-4 may include a second coupler 172-4 provided at the other side. A fixing hole 172a-4 for fixing may be formed in the second coupler 172-4.

The bracket 200-4 may be formed to correspond to the structure of the magnetron 100-4. The bracket 200-4 may include a first bent support 211-4 provided to support the first coupler 171-4.

The first bent support 211-4 may have one side open. In addition, the first bent support 211-4 may also include a bead 231-4 provided to be inserted into the fixing hole 171a-4 of the first coupler 171-4. When the first coupler 171-4 is inserted into the first bent support 211-4, the bead 231-4 is inserted into the fixing hole 171a-4 to fix the magnetron 100-4.

The magnetron 100-4 may include a second coupler 172-4 and a third coupler 174-4 provided at the opposite side of the first coupler 171-4. The second coupler 172-4 and the third coupler 174-4 may be formed at the same side. The second coupler 172-4 and the third coupler 174-4 may be provided at lower regions of the magnetron 100-4.

The bracket 200-4 may include support slots 221-4 and 222-4 provided to support the second coupler 172-4 and the third coupler 174-4, respectively.

The support slots 221-4 and 222-4 may include a first support slot 221-4 provided to support the second coupler 172-4 and a second support slot 222-4 provided to support the third coupler 174-4.

The first support slot 221-4 may include a bead 232-4 provided to be inserted into a fixing hole 172a-4 of the second coupler 172-4. In addition, the second support slot 222-4 may include a bead 234-4 provided to be inserted into a fixing hole 174a-4 of the third coupler 174-4.

After the second coupler 172-4 and the third coupler 174-4 of the magnetron 100-4 are first fixed to the first support slot 221-4 and the second support slot 222-4, the first coupler 171-4 may be fixed to the support 211-4.

By using the magnetron 100-4 and the bracket 200-4 according to an embodiment of the present disclosure, the magnetron 100-4 may be mounted on the bracket 200-4 without an additional fastening member (not shown). Therefore, manufacturing efficiency of the cooking appliance 1 including the magnetron 100-4 may be increased and manufacturing costs therefor may be reduced.

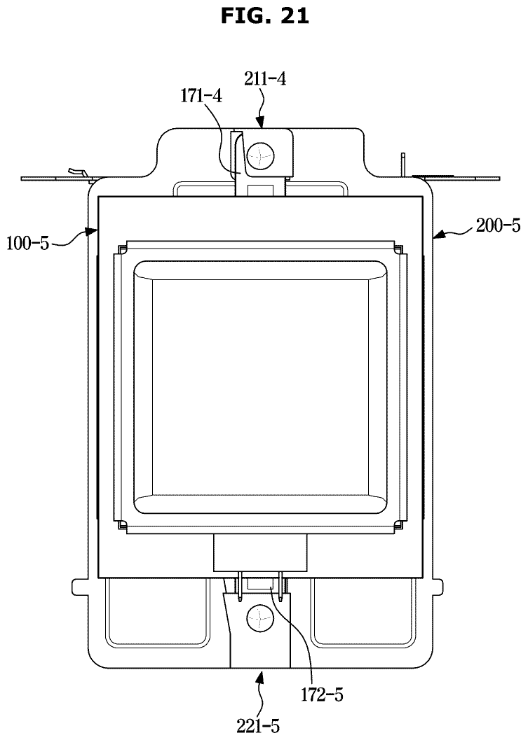

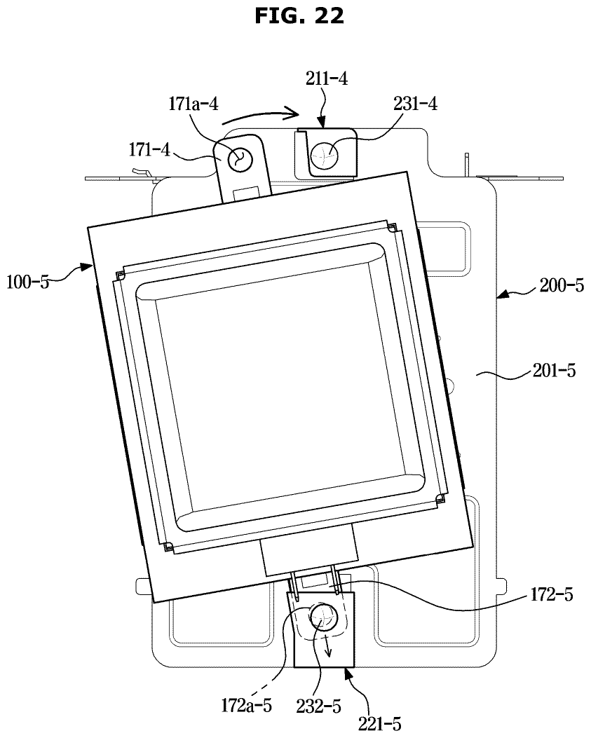

FIG. 21 is a view illustrating a state where a magnetron is mounted on a bracket according to an embodiment of the present disclosure. FIG. 22 is a view for describing a method of mounting the magnetron on the bracket of FIG. 21.

A magnetron 100-5 according to an embodiment may include a first coupler 171-4 provided at one side. A fixing hole 171a-4 for fixing may be formed in the first coupler 171-4. The first coupler 171-4 may be provided at an upper region of the magnetron 100-4.

In addition, the magnetron 100-5 may include a second coupler 172-5 provided at the other side. A fixing hole 172a-5 for fixing may be formed in the second coupler 172-5.

The bracket 200-5 may be formed to correspond to the structure of the magnetron 100-5. The bracket 200-5 may include a first bent support 211-4 provided to support the first coupler 171-4.

The first bent support 211-4 may have an side open. In addition, the first bent support 211-4 may include a bead 231-4 provided to be inserted into the fixing hole 171a-4 of the first coupler 171-4. When the first coupler 171-4 is inserted into the first bent support 211-4, the bead 231-4 is inserted into the fixing hole 171a-4 to fix the magnetron 100-5.

The magnetron 100-5 may include a second coupler 172-5 provided at the opposite site of the first coupler 171-4. The second coupler 172-5 may be provided at a lower region of the magnetron 100-5.

The bracket 200-5 may include a support slot 221-5 provided to support the second coupler 172-5.

The support slot 221-5 may include a bead 232-5 provided to be inserted into the fixing hole 172a-5 of the second coupler 172-5.

After the second coupler 172-5 of the magnetron 100-5 is first inserted into the second support slot 221-5 and fixed thereby, the first coupler 171-4 may be fixed to the support 211-4.

According to the magnetron 100-5 and the bracket 200-5 according to an embodiment of the present disclosure, the magnetron 100-5 may be mounted on the bracket 200-5 without an additional fastening member (not shown). Therefore, manufacturing efficiency of the cooking appliance 1 including the magnetron 100-5 may be increased and manufacturing costs therefor may be reduced.

The cooking appliance according to an embodiment may include a main body 10 forming a cooking chamber 21 and a machine room 30, a magnetron 100 disposed in the machine room 30, provided to supply high-frequency waves into the cooking chamber 21, and including couplers 171, 172, 173, and 174 having fixing holes 171a, 172a, 173a, and 174a, and a bracket 200 used to mount the magnetron 100 on the main body 10 and including a support 211 including a bead 230 inserted into the fixing hole, wherein the support 211 is designed to be elastically deformable while the magnetron is mounted on the bracket and to be restored after the magnetron is mounted on the bracket allowing the bead to be inserted into the fixing hole.

The coupler may include a first coupler 171 formed at one side of the magnetron and a second coupler 172 formed at the opposite side of the first coupler, and the support may be formed to correspond to at least one of the first coupler 171 and the second coupler 172.

The support may include a first bent support 211 provided to support the first coupler 171 and a second bent support 212 provided to support the second coupler 172.

The magnetron may further include a third coupler 173 provided at the same side as the first coupler 171 and a fourth coupler 174 provided at the same side as the second coupler 172, and the support may further include a third bend support 214 provided to support the fourth coupler 174.

The support may further include a fourth bent support 213 provided to support the third coupler 173.

The magnetron may include upper couplers 171 and 173 provided at upper regions of the magnetron and lower couplers 172 and 174 provided at lower regions of the magnetron.

The support may be provided to support the upper couplers 171 and 173 and the bracket may further include support slots 221 and 222 provided to support the lower couplers 172 and 174.

The upper coupler may include a first upper coupler 171 and a second upper coupler 173 formed at the same side as the first upper coupler, and the support may be provided to support the first upper coupler.

The second upper coupler may be coupled to the bracket by a fastening member 300.

The lower coupler may include a first lower coupler 172 symmetrically arranged to the first upper coupler 171 and a second lower coupler 174 symmetrically arranged to the second upper coupler 173. The support slot may include a first support slot 221 provided to support the first lower coupler 172, and a second support slot 222 provided to support the second lower coupler 174.

The support slot may include a bead 230 to be inserted into the fixing hole.

The support slot may include slopes 2212 and 2222 formed by partially inclining the support slots to allow the lower couplers to be slantly inserted to the support slots.

The magnetron may be mounted by inserting the lower coupler into the support slot along the slope and rotating the magnetron in the state of being inserted in the support slot to join the upper coupler to the support.

The magnetron may include a high-frequency generator configured to generate high-frequency waves supplied into the cooking chamber 21 and a yoke 110 forming an accommodation space to accommodate the high-frequency generator, wherein the yoke may include a yoke main body 111 with one side open and a yoke cover 112, on which the support is formed, forming the accommodation space by covering the open side of the yoke main body.

The support may be formed by lancing.

A cooking appliance according to an embodiment may include an inner case 20 forming a cooking chamber 21, an outer case 40 covering a machine room 30 located outside the inner case 20, a magnetron 100 including a high-frequency generator configured to generate high-frequency waves supplied into the cooking chamber 21 and a yoke 110 forming an accommodation space to accommodate the high-frequency generator, and a bracket 200 provided to couple the magnetron 100 to the inner case 20, wherein the yoke 110 may include couplers 171, 172, 173, and 174 provided to be coupled to the bracket 200 and having fixing holes 171a, 172a, 173a, and 174a, and the bracket 200 may include bent supports 211, 213, and 214 including beads inserted into the fixing holes 171a, 172a, 173a, and 174a.

The coupler may include upper couplers 171 and 173 provided at upper regions of the yoke and lower couplers 172 and 174 provided at lower regions of the yoke. The bracket 200 may include support slots 221 and 222 into which the lower couplers are inserted.

The support slots may include beads 232 and 234 provided to be inserted into the fixing holes 172a and 174a of the lower couplers.

A cooking appliance according to an embodiment may include a main body 10 including an inner case 20 separating a cooking chamber 21 from a machine room 30, a magnetron 100 located in the machine room, configured to supply high-frequency waves into the cooking chamber 21, and including a plurality of couplers 171, 172, 173, and 174 having fixing holes 171a, 172a, 173a, and 174a, and a bracket 200 provided to couple the magnetron 100 to the inner case 20, wherein the bracket 200 may include a support 211 provided to support at least one of the plurality of couplers and including a bead 230 inserted into the fixing hole.

The plurality of couplers may include upper couplers 171 and 173 provided at upper regions of the magnetron 100 and lower couplers 172 and 174 provided at lower regions of the magnetron 100. The bracket 200 may further include support slots 221 and 222 provided to support the lower couplers.

According to an aspect of the present disclosure, a magnetron may be easily mounted on a bracket.

According to an aspect of the present disclosure, a magnetron may be mounted on a bracket without an additional fastening member.

According to an aspect of the present disclosure, manufacturing efficiency of a cooking appliance may be increased and manufacturing costs may be reduced.

However, the effects achieved by the present disclosure are not limited to those given above, and any other effects not mentioned herein will be understood by those of ordinary skill in the art to which the present disclosure belong.

Although the embodiments of the present disclosure have been provided for illustrative purposes, the scope of the present disclosure is limited thereto. Various embodiments that may be modified and altered by those skilled in the art without departing from the principles and spirit of the present disclosure, the scope of which is defined in the claims, should be construed as falling within the scope of the present disclosure.

What is claimed is:

1. A cooking appliance comprising:
a main body having a cooking chamber and a machine room;
a magnetron in the machine room to supply high-frequency waves into the cooking chamber, the magnetron including a coupler having a fixing hole; and
a bracket used to mount the magnetron on the main body,
wherein the bracket comprises:
a bracket body on which the magnetron is mounted; and
a support at the bracket body to support the coupler, the support including a bead protruding toward the bracket body to be inserted into the fixing hole, and
wherein the support is elastically deformable while the magnetron is mounted on the bracket in a direction opposite to a direction where the bead protrudes by a pressure applied to the bead by the coupler and to be restored after the magnetron is mounted on the bracket to allow the bead to be inserted into the fixing hole.

2. The cooking appliance according to claim 1, wherein the coupler comprises a first coupler formed at one side of the magnetron and a second coupler formed at an opposite side of the first coupler, and the support is formed to correspond to at least one of the first coupler and the second coupler.

3. The cooking appliance according to claim 2, wherein the support comprises a first bent support to support the first coupler and a second bent support to support the second coupler.

4. The cooking appliance according to claim 3, wherein the magnetron further comprises a third coupler at a same side as the first coupler and a fourth coupler at a same side as the second coupler, and
the support further comprises a third bend support to support the fourth coupler.

5. The cooking appliance according to claim 4, wherein the support further comprises a fourth bent support to support the third coupler.

6. The cooking appliance according to claim 1, wherein the magnetron comprises an upper coupler at an upper region of the magnetron and a lower coupler at a lower region of the magnetron.

7. The cooking appliance according to claim 6, wherein the support is to support the upper coupler, and
the bracket further comprises a support slot to support the lower coupler.

8. The cooking appliance according to claim 7, wherein the upper coupler comprises a first upper coupler and a second upper coupler formed at a same side as the first upper coupler, and
the support is to support the first upper coupler.

9. The cooking appliance according to claim 8, wherein the second upper coupler is coupled to the bracket by a fastening member.

10. The cooking appliance according to claim 8, wherein the lower coupler comprises a first lower coupler symmetrically arranged to the first upper coupler and a second lower coupler symmetrically arranged to the second upper coupler, and
the support slot comprises a first support slot to support the first lower coupler, and a second support slot to support the second lower coupler.

11. The cooking appliance according to claim 7, wherein the support slot comprises a bead to be inserted into the fixing hole.

12. The cooking appliance according to claim 7, wherein the support slot comprises a slope formed by partially inclining the support slot to allow the lower coupler to be slantly inserted to the support slot.

13. The cooking appliance according to claim 12, wherein the magnetron is mounted by inserting the lower coupler into the support slot along the slope and rotating the magnetron in a state of being inserted in the support slot to join the upper coupler to the support.

14. The cooking appliance according to claim 1, wherein the magnetron further comprises a high-frequency generator configured to generate high-frequency waves supplied into the cooking chamber and a yoke forming an accommodation space to accommodate the high-frequency generator, and
wherein the yoke comprises a yoke main body with one side open and a yoke cover, on which the support is formed, forming the accommodation space by covering the open side of the yoke main body.

15. The cooking appliance according to claim 1, wherein the support is formed by lancing.

16. The cooking appliance according to claim 2, wherein:
the support comprises:
a first support slot to support the first coupler the first support slot including a first bead; and
a second support slot to support the second coupler, the second support slot including a second bead; and
in response to inserting the second coupler into the second support slot thereby inserting the second bead into a fixing hole of the second coupler, the bracket is rotated with respect to the second bead so that the first coupler is inserted into the first support slot thereby inserting the first bead into a fixing hole of the first coupler to mount the magnetron to the bracket.

17. The cooking appliance according to claim 10, wherein:
the first support slot includes a first bead and the second support slot includes a second bead; and
in response to inserting the second lower coupler into the second support slot thereby inserting the second bead into a fixing hole of the second lower coupler, the bracket is rotated with respect to the second bead so that the first lower coupler is inserted into the first support slot thereby inserting the first bead into a fixing hole of the first lower coupler to mount the magnetron to the bracket.
